(19) United States
(12) Patent Application Publication
(10) Pub. No.: US 2026/0304533 A1
(43) Pub. Date: Oct. 1, 2026

(54) COMMUNICATION DEVICE, PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Harumichi MORITA, Matsumoto (JP)

(21) Appl. No.: 19/577,466

(22) Filed: Mar. 25, 2026

(30) Foreign Application Priority Data
Mar. 27, 2025 (JP) 2025-052906

(51) Int. Cl. H04W 76/19; H04W 76/18

(52) U.S. Cl. CPC H04W 76/19; H04W 76/18

(57) ABSTRACT

A communication device according to the present disclosure includes a connection unit, a notification unit, an instruction receiving unit, and a reconnection unit. The connection unit connects to an access point by a Device Provisioning Protocol (DPP). The notification unit performs notification related to reconnection when a connection with the access point connected by the DPP is disconnected. The instruction receiving unit receives a selection instruction for selecting whether to perform the reconnection. When performing reconnection is selected, the reconnection unit performs the reconnection with the access point by the DPP.

The present application is based on, and claims priority from JP Application Serial Number 2025-052906, filed Mar. 27, 2025, the disclosure of which is hereby incorporated by reference herein in its entirety.

### BACKGROUND

### 1. Technical Field

The present disclosure relates to a communication device, a processing method, and a non-transitory computer-readable storage medium storing a program.

### 2. Related Art

Various wireless setting methods for establishing a wireless communication connection between a communication device and an access point have been proposed. As such wireless setting methods, for example, AirStation One-Touch Secure System (AOSS) (registered trademark; the same applies hereinafter) and Wi-Fi Protected Setup-Push Button Configuration (WPS-PBC) have been proposed. Here, Wi-Fi is a registered trademark, and the same applies hereinafter.

Incidentally, in recent years, the Wi-Fi Alliance has developed a function called Wi-Fi Easy Connect (registered trademark) as a wireless setting method for establishing a wireless communication connection between a communication device and an access point. The function is a technique in which a device called a configurator provides access point information to a device called an enrollee in accordance with a Device Provisioning Protocol (DPP). Accordingly, the enrollee that has acquired the access point information can wirelessly connect to the access point.

Further, JP-T-2023-523957 discloses that an enrollee device transmits a DPP Reconfiguration Announcement message to a configurator device as a process of DPP Reconfiguration.

However, in the technique described in JP-T-2023-523957, since the communication device automatically starts transmission of DPP Reconfiguration Announcement, there is a concern that power and bandwidth consumption for communication may increase.

Therefore, in a communication device that connects to an access point using the DPP, it is desirable to develop a technique for reducing power and bandwidth consumption required for communication for reconnection due to disconnection.

### SUMMARY

A communication device according to the present disclosure includes a connection unit configured to connect to an access point by a Device Provisioning Protocol (DPP), a notification unit configured to perform notification related to reconnection when a connection with the access point connected by the DPP is disconnected, an instruction receiving unit configured to receive a selection instruction for selecting whether to perform the reconnection, and a reconnection unit configured to perform the reconnection with the access point by the DPP when performing the reconnection is selected.

A processing method performed by a communication device, according to the present disclosure includes connecting to an access point by a Device Provisioning Protocol (DPP), performing notification related to reconnection when a connection with the access point connected by the DPP is disconnected, receiving a selection instruction for selecting whether to perform the reconnection, and performing the reconnection with the access point by the DPP when performing the reconnection is selected.

A non-transitory computer-readable storage medium storing a program according to the present disclosure, causes a computer of a communication device to execute a process, the process including: connecting to an access point by a Device Provisioning Protocol (DPP), performing notification related to reconnection when a connection with the access point connected by the DPP is disconnected, receiving a selection instruction for selecting whether to perform the reconnection, and performing the reconnection with the access point by the DPP when performing the reconnection is selected.

### BRIEF DESCRIPTION OF THE DRAWINGS

FIG. 1 is a schematic diagram showing a configuration example of an information processing system including a communication device.

FIG. 2 is a block diagram showing an example of a configuration of the communication device.

FIG. 3 is a sequence chart showing an example of a flow at the time of wireless setting and disconnection according to a wireless setting method defined by DPP.

FIG. 4 is a schematic diagram showing an example of a series of user interface images displayed on the communication device.

FIG. 5 is a block diagram showing an example of a configuration of a terminal device.

FIG. 6 is a block diagram showing an example of a configuration of an access point.

FIG. 7 is a block diagram showing an example of a hardware configuration of a computer included in the communication device, the terminal device, or the access point.

### DESCRIPTION OF EMBODIMENTS

Hereinafter, embodiments and the like will be described with reference to the drawings. For clarity, certain descriptions and drawings may be omitted or simplified as appropriate. In the drawings, the same elements are denoted by the same reference signs, and redundant description thereof will be omitted as appropriate. In addition, not all features or steps shown in any one of the drawings for describing the exemplary embodiments are necessarily indispensable, and some features or steps may be omitted. Furthermore, the order of the steps described in the drawings may be changed as appropriate.

### First Embodiment

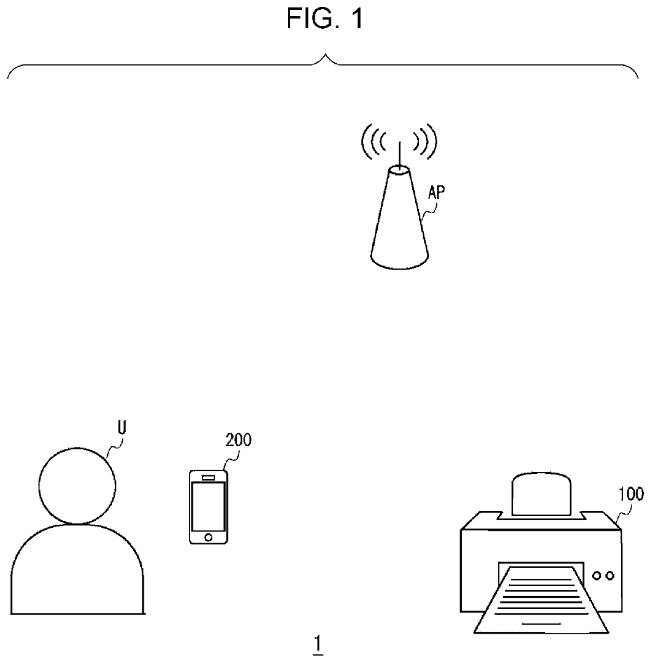

A first embodiment will be described. FIG. 1 is a schematic diagram showing a configuration example of an information processing system 1 including a communication device 100 according to the embodiment. As shown in FIG. 1, the information processing system 1 may further include a terminal device 200 and an access point AP. As will be described later, the communication device 100 is a device that supports a plurality of different wireless setting methods, or a single wireless setting method, for establishing a wireless communication connection with the access point AP.

The information processing system 1 according to the present embodiment performs reconnection after a wireless communication connection established between the communication device 100 and the access point AP is disconnected, and has a feature in a process for this reconnection. Hereinafter, together with the configuration example of the information processing system 1, a process from a state in which the wireless communication connection is not established, including a process which can also be used at the time of the reconnection, will also be described.

When the communication device 100 is in a state in which a wireless communication connection with the access point AP has not yet been established, the communication device 100 establishes a wireless communication connection with the access point AP by any wireless setting method selected by a user U. When the communication device 100 supports only one wireless setting method, the communication device 100 establishes a wireless communication connection with the access point AP by that wireless setting method; however, description of this example is omitted because it can be substituted by description of one of the plurality of different wireless setting methods described above. Specifically, the access point AP is, for example, a wireless Local Area Network (LAN) router.

In the present embodiment, the communication device 100 is a printer that prints information on media such as paper. However, the communication device 100 may be any device having a communication function and is not necessarily limited to a printer.

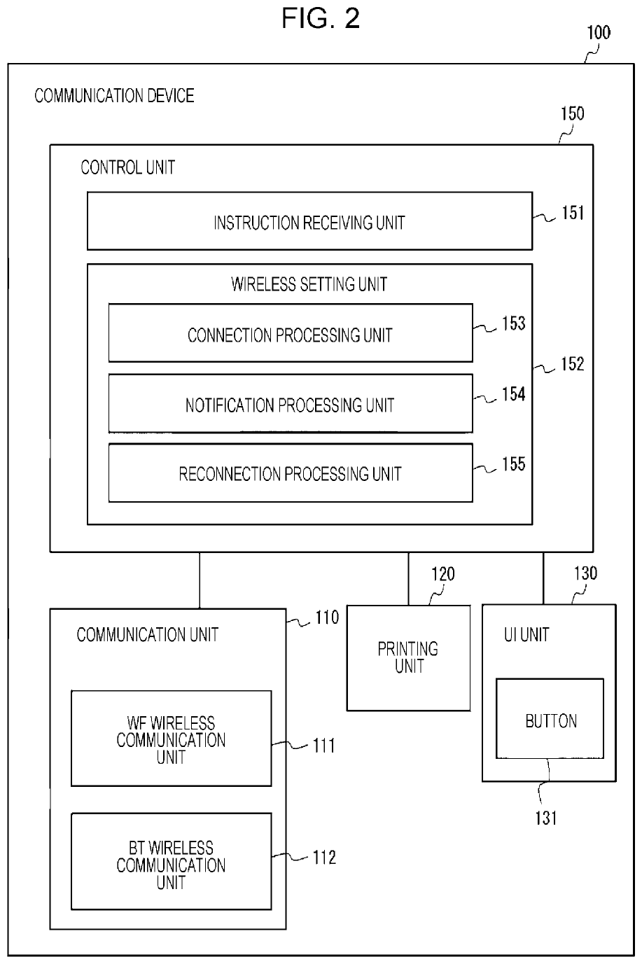

FIG. 2 is a block diagram showing an example of a configuration of the communication device 100. As shown in FIG. 2, the communication device 100 includes a communication unit 110, a printing unit 120, a user interface (UI) unit 130, and a control unit 150.

The communication unit 110 is a hardware circuit that wirelessly communicates with another device in accordance with a predetermined communication standard and may include a program such as firmware. The communication unit 110 includes a WF wireless communication unit 111 and a BT wireless communication unit 112.

The WF wireless communication unit 111 is a circuit that performs communication in accordance with a first wireless communication standard. That is, the WF wireless communication unit 111 transmits or receives information in accordance with the first wireless communication standard. In the present embodiment, specifically, the WF wireless communication unit 111 performs wireless communication in accordance with the Wi-Fi standard.

The BT wireless communication unit 112 is a circuit that performs communication in accordance with a second wireless communication standard. That is, the BT wireless communication unit 112 transmits or receives information in accordance with the second wireless communication standard. In the present embodiment, the BT wireless communication unit 112 performs Bluetooth (registered trademark; the same applies hereinafter) communication in accordance with the Bluetooth standard. More specifically, in the present embodiment, the BT wireless communication unit 112 performs wireless communication in accordance with a Bluetooth Low Energy (BLE) standard, which is a Bluetooth low power consumption standard.

The printing unit 120 includes a printing engine, which is a mechanical configuration that performs printing on media. In the present embodiment, ink jet printing is described as a configuration of the printing unit 120. However, the printing unit 120 may include a printing engine configured to perform printing using a coloring material (toner) by an electrophotographic method. In addition, the media is, for example, paper, but may be cloth or another material.

In the present embodiment, the printing unit 120 includes, as a printing engine, for example, a print head that ejects a coloring material onto media. The print head performs ink jet printing using a supplied coloring material, specifically ink. The printing engine may further include, in addition to the print head, a media container that holds media, a transport mechanism that transports the media from the media container to a position facing the print head, a drive mechanism that drives a carriage including the print head, and other components. In this case, the printing unit 120 prints information such as an image on the media by ejecting the coloring material from the print head onto the media transported by the transport mechanism.

The UI unit 130 is a component that functions as a user interface. In the present embodiment, the UI unit 130 includes a display. The UI unit 130 may include an input device such as a button or a pointing device that receives input operations from the user U. The UI unit 130 may be implemented as a touch panel in which an input device and a display are integrally configured. In the present embodiment, the UI unit 130 as an input device includes a button 131 for the user U to input an instruction such as a setting start instruction to be described below to the communication device 100. The button 131 may be a physical button or a virtual button displayed on a touch panel.

The control unit 150 controls the operation of the communication device 100. In particular, as a function for establishing a wireless communication connection between the access point AP outside the communication device 100 and the WF wireless communication unit 111, the control unit 150 includes an instruction receiving unit 151 and a wireless setting unit 152, as shown in FIG. 2.

The instruction receiving unit 151 can also receive an input of an instruction to cause the communication device 100 to establish the wireless communication connection with the access point AP in a state where the wireless communication connection is not established. Hereinafter, the instruction will also be referred to as a setting start instruction.

In addition, when the wireless communication connection with the access point AP is disconnected during the wireless communication connection, the instruction receiving unit 151 receives a selection instruction for selecting whether to perform the reconnection, that is, an input for instructing the communication device 100 to select whether to perform the reconnection.

The user U inputs the setting start instruction or the selection instruction to the communication device 100 by operating the button 131 described above. The button for receiving various operations, such as operation of the selection instruction and operation of the setting start instruction, may be a common button 131 or may be a plurality of buttons. When the common button 131 is used, the time period or the number of times determined as a press may be varied according to the operation content. Here, “operating the button 131” includes the operation of pressing the button 131 when the button 131 is a physical button. When the button 131 is operated, the instruction receiving unit 151 receives an input of the setting start instruction, the selection instruction, or the like according to the operation content.

The wireless setting unit 152 executes a process of performing wireless settings in the communication device 100. That is, the wireless setting unit 152 executes a process for establishing the wireless communication connection between the access point AP and the WF wireless communication unit 111. In the processing example described in the present embodiment, the wireless setting unit 152 starts a DPP standby process and a non-DPP standby process in response to reception of input of a setting start instruction by the instruction receiving unit 151, however, only one of them may be started.

Here, the DPP standby process is a process of waiting for, from another device, a signal for establishing a wireless communication connection between the communication device 100 and the access point AP, the signal being in accordance with a wireless setting method defined by the DPP. Note that the DPP standby process will be described in detail later. In this way, the communication device 100 supports the wireless setting method defined by the DPP.

In addition, the non-DPP standby process is a process of waiting for, from another device, a signal for establishing a wireless communication connection between the communication device 100 and the access point AP, the signal being in accordance with a predetermined wireless setting method other than DPP. The non-DPP standby process may be a process using a wireless setting method other than DPP. For example, the communication device 100 only needs to support at least one wireless setting method as a wireless setting method other than DPP. Here, four types of wireless setting methods, that is, a first non-DPP method, a second non-DPP method, a third non-DPP method, and a fourth non-DPP method, will be briefly described.

The first non-DPP method is a wireless setting method defined by WPS-PBC, although a detailed description thereof will be omitted. WPS-PBC is a wireless setting method that employs a push-button system and was defined by the Wi-Fi Alliance. The second non-DPP method is a wireless setting method defined by AOSS, although a detailed description thereof will be omitted. AOSS is a wireless setting method that employs a push-button system and was defined by Buffalo. Both the third non-DPP method and the fourth non-DPP method are methods for performing the wireless setting of the communication device 100 using the terminal device 200 in which a setting application (application program) provided by the vendor of the communication device 100 is installed, for example. This setting application corresponds to a setting assistance unit 251, which will be described later. The terminal device 200 is a device that has the access point information. The terminal device 200 may be a terminal that has already established a wireless communication connection with the access point AP, that is, a terminal that has already joined a wireless LAN provided by the access point AP. In the third non-DPP method and the fourth non-DPP method, the access point information included in the terminal device 200 is transmitted to the communication device 100, and the communication device 100 establishes a wireless communication connection with the access point AP using the received access point information. Hereinafter, the third non-DPP method is also referred to as Wi-Fi Auto Connect (WAC). The fourth non-DPP method is also referred to as BLE-WAC.

In addition, when the communication device 100 receives a signal according to the wireless setting method defined by the DPP from another device, the wireless setting unit 152 stops the DPP standby process and the non-DPP standby process, and executes a DPP setting process. A portion of the wireless setting unit 152 that executes the DPP setting process will be described as a connection processing unit 153. The communication unit 110 and the connection processing unit 153 are examples of a connection unit that connects to the access point AP using the DPP. The connection processing unit 153 executes such connection via the communication unit 110. It should be noted that signal transmission and reception between devices are not limited to the above-described signals, and mean transmission and reception of radio waves indicating the signals between the devices. That is, in this case, the connection processing unit 153 starts communication according to the DPP with the device that is the transmission source of the signal in order to perform wireless setting of the communication device 100. Here, the DPP setting process is a predetermined setting process for establishing a wireless communication connection with the access point AP, and particularly, is a setting process according to the wireless setting method defined by the DPP.

Further, the wireless setting unit 152 includes a notification processing unit 154 and a reconnection processing unit 155 as units that perform processes when the established wireless communication connection is disconnected. Hereinafter, this process is referred to as a disconnection-time process.

When the connection with the access point AP connected by the DPP is disconnected, the notification processing unit 154 performs a notification related to reconnection via the UI unit 130. This notification can be made by displaying a UI image (not shown) on the UI unit 130. The notification processing unit 154 and the UI unit 130 are examples of a notification unit that performs notification related to reconnection when the connection with the access point AP connected by the DPP is disconnected.

Further, the instruction receiving unit 151 receives a selection instruction for selecting whether to perform reconnection for the disconnection-time process via the UI unit 130. An example in which this reception also uses the button 131 is given, however, a separately provided button, or a virtual button provided in the above-described UI image displayed as a notification on the UI unit 130, may also be used. The instruction receiving unit 151 and the UI unit 130 are examples of an instruction receiving unit that receives a selection instruction for selecting whether to perform reconnection. The instruction receiving unit is an acquisition unit that acquires such a selection.

When performing reconnection is selected, the reconnection processing unit 155 performs reconnection with the access point AP by the DPP via the communication unit 110. The reconnection processing unit 155 and the communication unit 110 are examples of a reconnection unit that performs reconnection with the access point AP by the DPP when performing reconnection is selected.

On the other hand, when the communication device 100 receives, from another device, a signal that is a target of waiting in the non-DPP standby process, the wireless setting unit 152 stops the DPP standby process and the non-DPP standby process, and executes a non-DPP setting process. That is, in this case, in order to perform wireless settings for the communication device 100, the wireless setting unit 152 starts communication with the device that is the transmission source of the signal according to the wireless setting method corresponding to the signal. Here, the non-DPP setting process is a predetermined setting process for establishing a wireless communication connection with the access point AP, and particularly, is a setting process according to a predetermined wireless setting method other than the DPP. In addition, the signal that is a target of waiting in the above-described non-DPP standby process is a signal in accordance with a predetermined wireless setting method other than the DPP, and in the present embodiment, is a signal in accordance with any one of the above-described four types of wireless setting methods.

When the setting start instruction is received, the wireless setting unit 152 may switch the UI image to be displayed on the UI unit 130 to a UI image for wireless setting (hereinafter referred to as a wireless setting image). During execution of the DPP standby process described below, an image of a two-dimensional code described below is displayed on the wireless setting image. Further, during execution of the DPP setting process or the non-DPP setting process, an image for notifying the user U that the setting is in progress is displayed in the wireless setting image. As described above, when the input of the setting start instruction is received, the wireless setting unit 152 displays an image corresponding to the progress of the establishment of the wireless communication connection between the communication device 100 and the access point AP on the UI unit 130 of the communication device 100.

In addition, the disconnection-time process may also be executed in the same manner when a wireless communication connection established by the non-DPP setting process is disconnected. Also in this case, after disconnection, reconnection with the access point AP is performed by the DPP.

Next, the wireless setting method defined by the DPP will be described. DPP is a wireless setting method standardized by the Wi-Fi Alliance, and the function for performing wireless setting using the wireless setting method is called Wi-Fi Easy Connect. In the present embodiment, the communication device 100 is at least a device having a Wi-Fi Easy Connect function. That is, the communication device 100 is a device that can execute a process according to the DPP. Further, the terminal device 200 and the access point AP may have a Wi-Fi Easy Connect function. When not only the communication device 100 but also the terminal device 200 and the access point AP have a Wi-Fi Easy Connect function, the communication device 100 can acquire access point information from the terminal device 200 using the wireless setting method defined by the DPP and establish a wireless communication connection with the access point AP.

Here, the terminal device 200 is a device that has access point information used to establish a wireless communication connection between the access point AP and the WF wireless communication unit 111. The terminal device 200 may be a terminal that has already established a wireless communication connection with the access point AP. In contrast, the communication device 100 is a device that does not yet have access point information. In the wireless setting method defined by the DPP, the access point information transmitted from the terminal device 200 to the communication device 100 is specifically information called a Configuration Object in DPP. The access point information transmitted from the terminal device 200 to the communication device 100 by the DPP may include, for example, at least one of a Service Set Identifier (SSID) and a password of a network provided by the access point AP. However, the access point information may be information required to establish a wireless communication connection with the access point AP, and may include other information instead of the SSID or the password or in addition to the SSID or the password.

In the wireless setting method defined by the DPP, access point information is transmitted from the terminal device 200 to the communication device 100 in accordance with the procedure defined by the DPP. Accordingly, the communication device 100 can establish a wireless communication connection with the access point AP. In the wireless setting method defined by the DPP, the terminal device 200 operates as a configurator defined by the DPP, and the communication device 100 operates as an enrollee defined by the DPP.

In this way, when wireless setting is performed using the wireless setting method defined by the DPP, the wireless setting unit 152 establishes a wireless communication connection between the access point AP and the WF wireless communication unit 111 in accordance with the procedure defined by the DPP (Wi-Fi Easy Connect).

In the DPP, a process of acquiring the access point information includes three phases. Specifically, the process by which the device that operates as the enrollee obtains the access point information, that is, a Configuration Object from the device that operates as the configurator includes three phases of Bootstrapping, Authentication, and Configuration.

The Bootstrapping is a process in which the enrollee provides predetermined information to the configurator. The predetermined information is information necessary for the configurator to start communication with the enrollee in the Authentication, which is the subsequent phase, and specifically includes a Bootstrapping Key defined by the DPP. The Bootstrapping Key is a public key of the enrollee. That is, the predetermined information is information that needs to be provided to the terminal device 200 in order for the terminal device 200, which is a configurator, to start, with respect to the communication device 100, communication in accordance with a predetermined communication procedure for the WF wireless communication unit 111 of the communication device 100, which is an enrollee, to receive access point information from the terminal device 200. In other words, the predetermined information is information that the communication device 100 needs to provide to the terminal device 200 in order to enable execution of predetermined communication by the terminal device 200, which is exemplified by communication in an Authentication phase described below. The predetermined information may include information such as a Media Access Control (MAC) address of the communication device 100. Hereinafter, the predetermined information described above, which is provided from the enrollee to the configurator in the Bootstrapping phase defined by the DPP, is also referred to as Bootstrapping information.

In the present embodiment, as a method of providing the predetermined information in Bootstrapping, there is a provision of a QR code (registered trademark; the same applies hereinafter). In the present embodiment, the provision of the QR code is realized by displaying the QR code on the UI unit 130, but it may also be realized by printing the QR code by the printing unit 120 instead of or in addition to displaying the QR code. On the other hand, the communication between the terminal device 200 and the communication device 100 in the Authentication phase and the Configuration phase is performed according to the Wi-Fi standard. That is, in the Authentication phase and the Configuration phase, the communication device 100 communicates with the terminal device 200 by using the WF wireless communication unit 111.

The Authentication is a process in which the terminal device 200, which is the configurator, and the communication device 100, which is the enrollee, authenticate each other and generate a shared key used for encrypting the transmission of the Configuration Object. That is, in this phase, a key for encrypting the access point information is generated. The terminal device 200 and the wireless setting unit 152 of the communication device 100 respectively generate the shared key based on, for example, Elliptic Curve Diffie-Hellman (ECDH) key exchange. In the Authentication phase, first, the terminal device 200, which is the configurator, transmits a signal called a DPP Authentication Request to the communication device 100, which is the enrollee. The signal includes a message generated by using predetermined information acquired from the communication device 100 in the Bootstrapping phase. Therefore, as described above, the predetermined information is information that is required to be provided to the terminal device 200 in order for the terminal device 200 to start the communication (DPP Authentication Request) according to the predetermined communication procedure with respect to the communication device 100. In the Authentication phase, after the DPP Authentication Request is transmitted, a signal called a DPP Authentication Response is transmitted from the enrollee to the configurator. Finally, a signal called a DPP Authentication Confirm is transmitted from the configurator to the enrollee.

The Configuration is a process of transmitting the access point information (Configuration Object) from the configurator to the enrollee by the encrypted communication using the shared key generated in the Authentication phase. Specifically, in the Configuration phase, first, the communication device 100, which is the enrollee, transmits a signal to the terminal device 200, which is the configurator, the signal being referred to as a DPP Configuration Request. Meanwhile, the configurator transmits the signal called the DPP Configuration Response to the enrollee. The DPP Configuration Response includes access point information (Configuration Object).

After performing Bootstrapping, when the WF wireless communication unit 111 of the communication device 100 receives a signal for the Authentication phase from the terminal device 200, the wireless setting unit 152 executes processes of the Authentication phase and the Configuration phase in accordance with the procedure defined by the DPP. As a result, the wireless setting unit 152 acquires the access point information from the terminal device 200. When the wireless setting unit 152 acquires the access point information, the wireless setting unit 152 performs the process of establishing the wireless communication connection with the access point AP by using the acquired access point information.

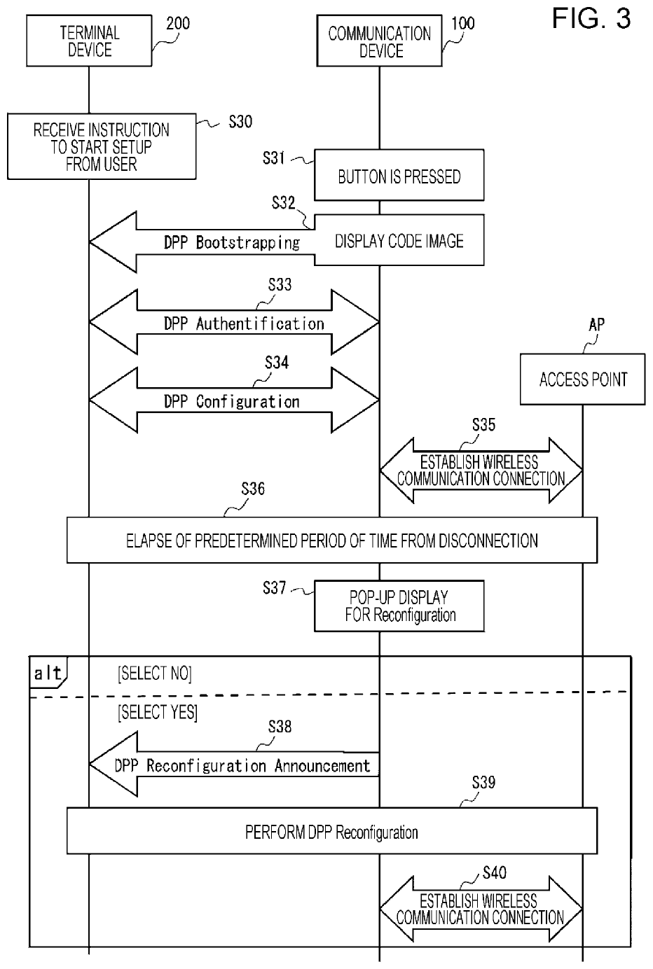

FIG. 3 is a sequence chart showing an example of a flow at the time of wireless setting and disconnection according to a wireless setting method defined by DPP. Hereinafter, the flow of wireless setting according to the wireless setting method defined by the DPP and a subsequent flow at the time of disconnection will be described with reference to FIG. 3. In FIG. 3, the terminal device 200 is, for example, a smartphone or a tablet terminal, but is not limited thereto.

In step S30, the user U inputs an instruction to start setup according to the DPP to the terminal device 200. That is, the user U inputs an instruction to implement wireless setting according to the DPP. The start instruction from the user U may be input via an application program such as the above-described setting application that operates on the terminal device 200. Accordingly, the setting assistance unit 251 (described later) of the terminal device 200 receives the setup start instruction.

Next, in step S31, the user U operates the above-described button 131 of the communication device 100. Accordingly, the instruction receiving unit 151 of the communication device 100 receives the setting start instruction, and the wireless setting unit 152 starts the DPP standby process and the non-DPP standby process. Therefore, in step S32, the wireless setting unit 152 of the communication device 100 performs a process of the Bootstrapping phase of DPP as the DPP standby process, and Bootstrapping information is provided from the communication device 100 to the terminal device 200. Specifically, the wireless setting unit 152 generates an image of a two-dimensional code such as a QR code in which Bootstrapping information is encoded, and causes the UI unit 130 to display the image. Thus, in the present embodiment, the DPP standby process includes a process of displaying, on the UI unit 130 of the communication device 100, a code image including information provided by the enrollee to the configurator in the Bootstrapping phase defined by the DPP. The wireless setting unit 152 may cause the printing unit 120 to print an image of the generated two-dimensional code. In response to this, the terminal device 200 acquires Bootstrapping information provided by the communication device 100. In addition, the wireless setting unit 152 of the communication device 100 waits for a DPP Authentication Request signal from the terminal device 200.

Next, in step S33, the terminal device 200 that has acquired the Bootstrapping information transmits a DPP Authentication Request to the communication device 100 using the WF wireless communication unit 211, which will be described later. When the WF wireless communication unit 111 of the communication device 100 receives this, the Authentication phase is started. Thus, in the present embodiment, the DPP standby process includes a process of waiting for a DPP Authentication Request from the terminal device 200. Thereafter, a process of the DPP Authentication phase is performed between the terminal device 200 and the communication device 100. Accordingly, a key for transmitting access point information by encrypted communication is generated.

Next, in step S34, a process in the DPP Configuration phase is performed between the terminal device 200 and the communication device 100. Accordingly, the access point information is transmitted from the terminal device 200 to the communication device 100, and the wireless setting unit 152 of the communication device 100 acquires the access point information.

Thereafter, in step S35, the wireless setting unit 152 of the communication device 100 uses the access point information acquired from the terminal device 200 to establish a wireless communication connection in accordance with the Wi-Fi standard as a wireless connection between the access point AP and the WF wireless communication unit 111 of the communication device 100. In other words, in step S35, the communication device 100 uses the access point information to join a wireless LAN provided by the access point AP. The series of processes from step S33 to step S35 is an example of a DPP setting process.

When the wireless connection is disconnected after the wireless setting according to the wireless setting method defined by the DPP is performed in this way, the following disconnection-time process is performed.

In step S36, the notification processing unit 154 or the connection processing unit 153 monitors whether the wireless communication connection is disconnected. Then, when disconnection occurs, the notification processing unit 154 determines whether a predetermined time has elapsed from the disconnection. When the predetermined time has not elapsed, the notification processing unit 154 does not proceed to the next process. However, the process may proceed to the next process without determining the elapse of the predetermined time.

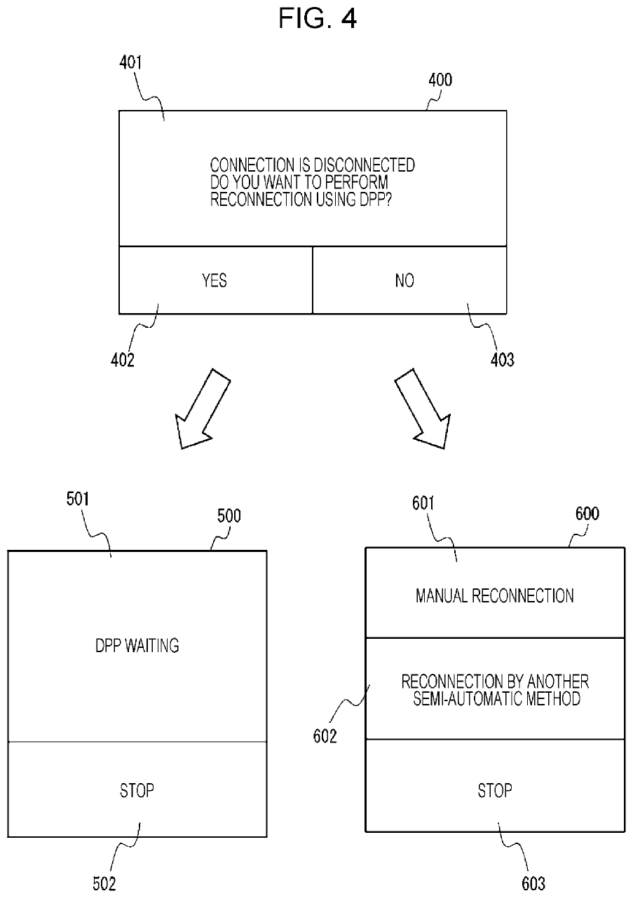

When the predetermined time has elapsed, in step S37, the notification processing unit 154 causes the UI unit 130 to display a UI image including a character string 401 for inquiring whether to perform reconnection using the DPP because the connection has been disconnected, as exemplified by a UI image 400 in FIG. 4. The UI image may be displayed as a pop-up, or may be displayed in a display form other than a pop-up. The UI image 400 can include a selection region 402 of “Yes” to be selected when the reconnection is executed and a selection region 403 of “No” to be selected when the reconnection is not executed. Here, a case where the UI unit 130 includes a touch panel will be described. As described above, the selection instruction may be received by the button 131. In this case, the press time or the number of presses of the button 131 may be made different between a case in which reconnection is executed and a case in which reconnection is not executed, or a plurality of buttons may be provided. Not limited to this example, when the connection with the access point AP connected by the DPP is disconnected, the notification processing unit 154 performs a notification related to reconnection via the UI unit 130. The instruction receiving unit 151 receives, via the UI unit 130, a selection instruction for selecting whether to perform reconnection.

When performing reconnection is selected, that is, when the selection region 402 is selected, the reconnection processing unit 155 performs reconnection with the access point AP by the DPP via the communication unit 110. In this case, since the connection may not be established immediately, the notification processing unit 154 may display a UI image including a character string 501 indicating that standby for DPP is in progress and a selection region 502 for receiving selection of cancellation, as exemplified by a UI image 500 shown in FIG. 4. The selection of the selection region 502 is not limited to the example in which the selection is received on the touch panel, and may be received by the button 131. As exemplified by the character string 501, when the instruction receiving unit 151 receives a selection instruction indicating that reconnection is to be performed, the notification processing unit 154 may notify, via the UI unit 130, information indicating that standby is in progress until reconnection is established. In addition, as exemplified in the selection region 502, the instruction receiving unit 151 may receive an interruption selection instruction for selecting whether to interrupt the reconnection during the reconnection by the reconnection processing unit 155, and the reconnection processing unit 155 may interrupt the reconnection when receiving the interruption selection instruction for interrupting the reconnection.

Here, the reconnection processing unit 155 transmits the radio wave indicating the DPP Reconfiguration Announcement as the reconnection based on the selection instruction (step S38), and executes the processing of the DPP Reconfiguration (step S39). The processing of DPP Reconfiguration corresponds to the processing of steps S33 and S34, and the processing of step S32 is unnecessary and is omitted.

In addition, when the connection is disconnected, as reconnection based on a selection instruction, the communication device 100 may transmit, to the terminal device 200, that is, to a configurator, a radio wave indicating the DPP Reconfiguration Announcement via the communication unit 110 by the reconnection processing unit 155. The terminal device 200 may receive this radio wave and perform notification related to reconnection. Then, when the instruction receiving unit 151 receives a selection instruction indicating that reconnection is to be performed from the terminal device 200, reconnection to the access point AP may be performed by the DPP.

On the other hand, when not performing reconnection is selected, that is, when the selection region 403 is selected, the reconnection processing unit 155 does not perform reconnection with the access point AP by the DPP via the communication unit 110. In addition, although not shown, when the notification processing unit 154 receives, by the instruction receiving unit 151, a selection instruction indicating that reconnection is not to be performed, the notification processing unit 154 may notify, via the UI unit 130, information indicating that communication with the access point AP is not possible.

However, as exemplified by a UI image 600 shown in FIG. 4, a UI image including a selection region 601 for selecting to perform manual reconnection, a selection region 602 for selecting to perform reconnection by another semi-automatic method, and a selection region 603 for receiving selection of cancellation may be displayed. When the selection region 601 is selected, reconnection is performed by selecting from a list of SSIDs and inputting a password. When the selection region 602 is selected, reconnection is performed by, for example, any one of the first to fourth non-DPP methods, or a method selected from among them. As exemplified by the selection regions 601 and 602, when the notification processing unit 154 receives, by the instruction receiving unit 151, a selection instruction indicating that reconnection is not to be performed, the notification processing unit 154 may notify, via the UI unit 130, information indicating a connection method that does not use DPP.

In addition, as at least part of the notification, the notification processing unit 154 may notify, via the UI unit 130, first information prompting selection of whether to perform reconnection, as exemplified by the UI image 400, together with second information (not shown) prompting selection of whether to provide notification of the first information at the next time or at subsequent times. When, in selection regarding the second information, not providing notification of the first information is selected, notification of the first information at the next time or at subsequent times is not performed.

As described above, when the reconnection processing unit 155 receives, by the instruction receiving unit 151, a selection instruction indicating that reconnection is to be performed, the reconnection processing unit 155 may start transmission of radio waves for reconnection, and when the reconnection processing unit 155 receives, by the instruction receiving unit 151, a selection instruction indicating that reconnection is not to be performed, the reconnection processing unit 155 may not transmit the radio waves for reconnection. Here, the radio waves for reconnection may be radio waves indicating the above-described DPP Reconfiguration Announcement, that is, radio waves indicating a DPP reconfiguration announcement.

Alternatively, when the connection is disconnected, the reconnection processing unit 155 starts transmission of radio waves for reconnection. Then, when the instruction receiving unit 151 receives the selection instruction indicating that the reconnection is performed, the reconnection processing unit 155 may continue the transmission of the radio waves for reconnection. In this case, at least transmission of radio waves required until a selection instruction is received even at the time of disconnection is performed. Then, when the instruction receiving unit 151 receives the selection instruction indicating that the reconnection is not performed, the reconnection processing unit 155 may stop the transmission of the radio waves for the reconnection.

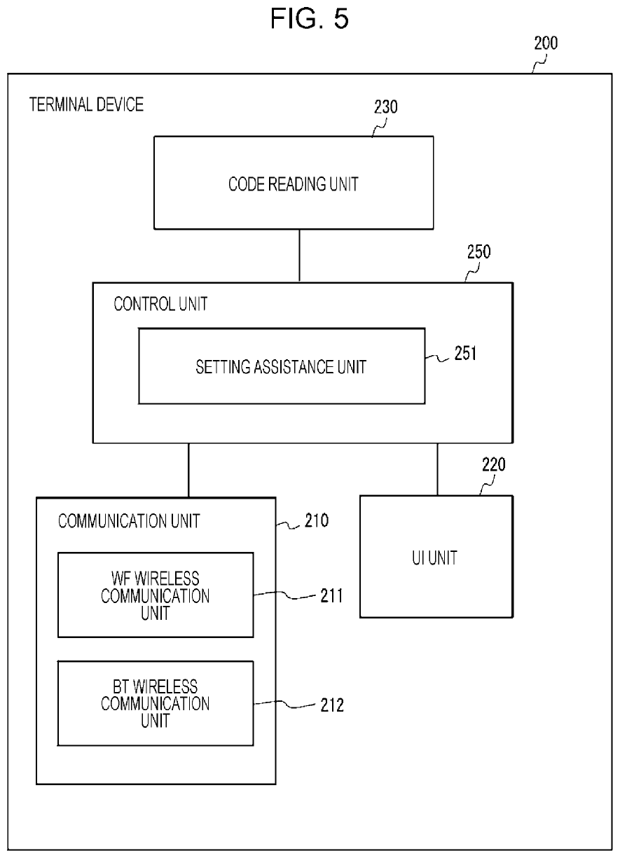

Next, the terminal device 200 will be described. The terminal device 200 is a device carried and operated by the user U, and is, for example, a smartphone, a tablet terminal, a personal computer, or the like. FIG. 5 is a block diagram showing an example of the configuration of the terminal device 200. As shown in FIG. 5, the terminal device 200 includes a communication unit 210, a UI unit 220, a code reading unit 230, and a control unit 250.

The communication unit 210 is a hardware circuit that wirelessly communicates with another device in accordance with a predetermined communication standard and may include a program such as firmware. The communication unit 210 includes a WF wireless communication unit 211 and a BT wireless communication unit 212.

The WF wireless communication unit 211 is a circuit that performs communication in accordance with the above-described first wireless communication standard. Specifically, the WF wireless communication unit 211 performs wireless communication in accordance with the Wi-Fi standard.

The BT wireless communication unit 212 is a circuit that performs communication in accordance with the above-described second wireless communication standard. In the present embodiment, the BT wireless communication unit 212 performs Bluetooth communication, which is communication in accordance with the Bluetooth standard. More specifically, in the present embodiment, the BT wireless communication unit 212 performs wireless communication in accordance with the BLE standard.

The UI unit 220 is a component that functions as a user interface. Specifically, the UI unit 220 is a user interface device that includes an input device such as a button or a pointing device that receives input operations from the user U, and a display. The UI unit 220 may be a touch panel in which an input device and a display are integrated.

The code reading unit 230 is a reader that reads a code image such as a QR code. The code reading unit 230 includes, for example, a camera as hardware for reading, but may also include a scanner. The code reading unit 230 decodes the captured or scanned code image and reads the information represented by the code image. Therefore, the code reading unit 230 can read the code image of the Bootstrapping information displayed or printed by the communication device 100.

The control unit 250 controls the operation of the terminal device 200. In particular, the control unit 250 includes a setting assistance unit 251 as a configuration for setting wireless communication of the communication device 100. The setting assistance unit 251 may be realized by, for example, a setting application installed on the terminal device 200.

When an input of an instruction to start setup from the user U is received, the setting assistance unit 251 executes a process of assisting with the setting of wireless communication in the communication device 100. Specifically, the setting assistance unit 251 executes either a process for wireless setting according to the third non-DPP method (WAC), a process for wireless setting according to the fourth non-DPP method (BLE-WAC), or a process for wireless setting according to the wireless setting method defined by the DPP. The setting assistance unit 251 may support all of these three types of wireless setting methods, or may support only one or two types of wireless setting methods. When the setting assistance unit 251 supports a plurality of wireless setting methods, the setting assistance unit 251 may use a wireless setting method selected by input from the user U from among the wireless setting methods.

As described above, when the setting assistance unit 251 receives an input of an instruction to start setup according to the WAC, the setting assistance unit 251 starts searching for (scanning) a WAC-dedicated SSID using the WF wireless communication unit 211. Furthermore, when the WF wireless communication unit 211 receives the WAC-dedicated SSID, the setting assistance unit 251 causes the WF wireless communication unit 211 to transmit a WAC request signal to the communication device 100. Then, when a temporary wireless communication connection with the communication device 100 starts, the setting assistance unit 251 transmits the access point information to the communication device 100 using the WF wireless communication unit 211.

Furthermore, when the setting assistance unit 251 receives an input of an instruction to start setup according to BLE-WAC, the setting assistance unit 251 starts searching for (scanning) BLE beacons from the communication device 100 using the BT wireless communication unit 212. Furthermore, when the BT wireless communication unit 212 receives a BLE beacon from the communication device 100, the setting assistance unit 251 causes the BT wireless communication unit 212 to transmit a BLE-WAC request signal to the communication device 100. Then, when the setting assistance unit 251 starts a temporary wireless communication connection with the communication device 100, the setting assistance unit 251 transmits access point information to the communication device 100 using the BT wireless communication unit 212.

Furthermore, when the setting assistance unit 251 receives an input of an instruction to start setup according to the DPP, the setting assistance unit 251 causes the UI unit 220 to display an image requesting the user U to read a code image (Bootstrapping information) provided by the communication device 100. Then, in response to the code reading unit 230 reading the code image including the Bootstrapping information, the setting assistance unit 251 starts a predetermined process for transmitting access point information to the communication device 100. That is, when the terminal device 200 acquires Bootstrapping information provided from the communication device 100, the setting assistance unit 251 causes the WF wireless communication unit 211 to transmit a DPP Authentication Request, and starts processing of a DPP Authentication phase. Thereafter, the setting assistance unit 251 executes processing of a DPP Configuration phase. Accordingly, the setting assistance unit 251 transmits the access point information to the communication device 100 using the WF wireless communication unit 211.

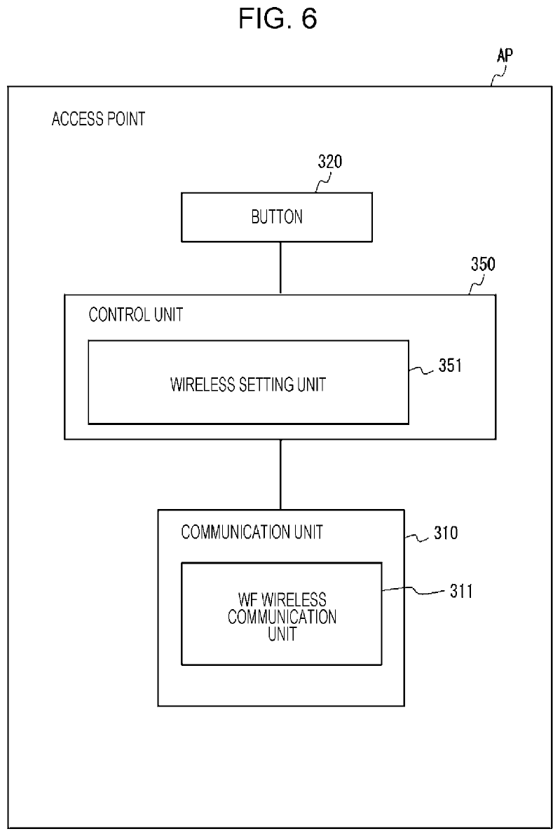

Next, the access point AP will be described. In the present embodiment, the access point AP constitutes a wireless LAN in accordance with the Wi-Fi standard. FIG. 6 is a block diagram showing an example of a configuration of the access point AP. As shown in FIG. 6, the access point AP includes a communication unit 310, a button 320, and a control unit 350.

As described above, the button 320 is a button for inputting an instruction to implement wireless settings according to WPS-PBC to the access point AP (WPS button), or a button for inputting an instruction to implement wireless settings according to AOSS to the access point AP (AOSS button). The access point AP may be provided with either a WPS button or an AOSS button, or may be provided with both.

The communication unit 310 is a hardware circuit that wirelessly communicates with another device in accordance with a predetermined communication standard and may include a program such as firmware. The communication unit 310 includes a WF wireless communication unit 311.

The WF wireless communication unit 311 is a circuit that performs communication in accordance with the above-described first wireless communication standard. Specifically, the WF wireless communication unit 311 performs wireless communication in accordance with the Wi-Fi standard.

The control unit 350 controls the operation of the access point AP. In particular, the control unit 350 includes a wireless setting unit 351 as a configuration for setting wireless communication between the access point AP and the communication device 100.

When the user U operates the button 320 as a WPS button, the wireless setting unit 351 executes a process for wireless setting according to the first non-DPP method (WPS-PBC). Furthermore, when the user U operates the button 320 as an AOSS button, the wireless setting unit 351 executes a process for wireless setting according to the second non-DPP method (AOSS). Specifically, as described above, when the user U operates the button 320, the wireless setting unit 351 causes the WF wireless communication unit 311 to transmit a WPS-dedicated SSID or an AOSS-dedicated SSID for a temporary connection with the communication device 100. Furthermore, when the wireless setting unit 351 receives a request for a temporary connection from the communication device 100 that has received the WPS-dedicated SSID or the AOSS-dedicated SSID, the wireless setting unit 351 starts a temporary wireless communication connection with the communication device 100. Then, the wireless setting unit 351 transmits the access point information to the communication device 100 using the WF wireless communication unit 311.

In addition, based on a request from the communication device 100 that has acquired access point information by any one of five wireless setting methods consisting of a wireless setting method defined by the DPP and four other types of wireless setting methods, the wireless setting unit 351 executes a process for establishing a wireless communication connection with the communication device 100.

The embodiment has been described above. As described above, the communication device 100 according to the present embodiment performs a wireless communication connection with the access point AP using the DPP, and makes a notification when this connection is disconnected due to, for example, replacement of the access point AP or deterioration of the radio wave environment. This notification is a notification for confirming whether to perform reconnection using the DPP. In response to this notification, when the user selects to perform reconnection using the DPP, transmission of radio waves for reconnection is started or continued, and when the user does not select to perform reconnection using the DPP, transmission of radio waves for reconnection is not performed or stopped.

Therefore, according to the present embodiment, in the communication device 100 that connects to an access point using DPP, it is possible to reduce power and bandwidth consumption required for communication for reconnection due to disconnection. For example, in the present embodiment, since it is possible to prevent Reconfiguration Announcement from being started when the user does not intend to perform Reconfiguration, it is possible to reduce power consumption and bandwidth consumption.

### Modification Example

In the above-described embodiment, in the DPP standby process, a process of providing a code image including Bootstrapping information is performed. However, when the communication device 100 has a Push Button Onboarding function defined by the DPP, as a modification example, the following process may be performed in the DPP standby process. That is, in this case, in the DPP standby process, a process of transmitting a Push Button Presence Announcement may be performed instead of or in addition to the process of providing a code image. A Push Button Presence Announcement is a signal defined by the DPP, which is used by the enrollee to notify the configurator that Bootstrapping information can be acquired using Push Button Onboarding.

In Push Button Onboarding, first, the communication device 100, which is the enrollee, transmits the above-described signal called Push Button Presence Announcement. That is, the wireless setting unit 152 of the communication device 100 causes the WF wireless communication unit 111 to transmit the signal. In response to this, the setting assistance unit 251 of the terminal device 200 as a configurator that has received an instruction to start setup according to DPP starts searching for a Push Button Presence Announcement signal using the WF wireless communication unit 211. When the signal is discovered, the setting assistance unit 251 transmits a signal called a Push Button Presence Announcement Response, as defined by the DPP, using the WF wireless communication unit 211. When the signal is received by the WF wireless communication unit 111 of the communication device 100, the subsequent process in Push Button Onboarding starts. Thus, in the modification example, the DPP standby process includes a process of waiting for a Push Button Presence Announcement Response from the terminal device 200. When the communication device 100 receives a DPP signal (Push Button Presence Announcement Response), that is, when a temporary connection based on DPP is requested from the terminal device 200, the wireless setting unit 152 determines that the wireless setting method to be used for setting is DPP.

In the modification example, when the DPP standby process is stopped, the transmission of the Push Button Presence Announcement is ended. That is, in this case, the wireless setting unit 152 ends the transmission of the Push Button Presence Announcement using the WF wireless communication unit 111. Furthermore, when the DPP standby process is stopped, the wireless setting unit 152 does not respond to the received Push Button Presence Announcement Response signal even when the signal is received from another device.

After the communication device 100, which is the enrollee, receives the Push Button Presence Announcement Response, the terminal device 200 and the communication device 100 perform Wi-Fi communication in the subsequent process in Push Button Onboarding. Accordingly, the terminal device 200 acquires the Bootstrapping information (public key) of the communication device 100. This acquisition process uses the Public Key Exchange (PKEX) technology defined by the DPP. After the Push Button Onboarding communication between the enrollee and the configurator is ended, the above-described Authentication phase and Configuration phase are processed.

According to the modification example, the communication device 100 can also support a wireless setting method using Push Button Onboarding. Therefore, usability can be improved.

### Other Modification Examples

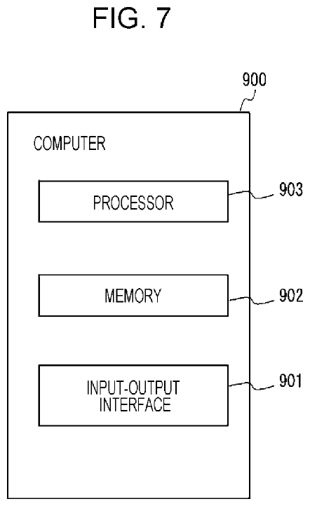

Although the embodiment and the modification example have been described above, the processes of the communication device 100, the terminal device 200, and the access point AP may be executed by a computer included in each device. The computer may be configured as a System on a Chip (SoC). FIG. 7 is a block diagram showing an example of a hardware configuration of the communication device 100, the terminal device 200, or the computer 900 included in the access point AP. As shown in FIG. 7, the computer 900 includes, for example, an input-output interface 901, a memory 902, and a processor 903.

The input-output interface 901 is used for communication with any circuit or device. The memory 902 is composed of, for example, a combination of a volatile memory and a nonvolatile memory. The memory 902 is used to store a program executed by the processor 903, data used for various processes, and the like. The processor 903 reads a program from the memory 902 and executes the program to perform various processes described in the above-described embodiment or modification example. The processor 903 may be, for example, a microprocessor, a microprocessor unit (MPU), a central processing unit (CPU), or the like. In addition, the processor 903 may include a plurality of processors.

The above-described program includes a group of instructions (or software code) for causing a computer, when read into the computer, to perform one or more functions described in the embodiment. The program may be stored in a non-transitory computer-readable medium or a tangible storage medium. By way of example, and not limitation, such computer-readable media or tangible storage media may include a random-access memory (RAM), a read-only memory (ROM), a flash memory, a solid-state drive (SSD) or other memory technology, a CD-ROM, a digital versatile disc (DVD), a Blu-ray (registered trademark) disc or other optical disc storage, a magnetic cassette, a magnetic tape, magnetic disk storage or another magnetic storage device. The program may be transmitted on a transitory computer-readable medium or a communication medium. By way of example, and not limitation, the transitory computer-readable medium or the communication medium includes electrical, optical, acoustical or other forms of propagated signals.

The present disclosure is not limited to the embodiments described above, and may be changed as appropriate within a range without departing from the spirit and scope of the disclosure.

What is claimed is:

1. A communication device comprising:
a connection unit configured to connect to an access point by a Device Provisioning Protocol (DPP);
a notification unit configured to perform notification related to reconnection when a connection with the access point connected by the DPP is disconnected;
an instruction receiving unit configured to receive a selection instruction for selecting whether to perform the reconnection; and
a reconnection unit configured to perform the reconnection with the access point by the DPP when performing the reconnection is selected.

2. The communication device according to claim 1, wherein
the reconnection unit starts transmission of a radio wave for the reconnection when the instruction receiving unit receives the selection instruction indicating that the reconnection is to be performed, and does not transmit the radio wave for the reconnection when the instruction receiving unit receives the selection instruction indicating that the reconnection is not to be performed.

3. The communication device according to claim 1, wherein
the reconnection unit continues transmission of a radio wave for the reconnection when the instruction receiving unit receives the selection instruction indicating that the reconnection is to be performed, and stops transmission of the radio wave for the reconnection when the instruction receiving unit receives the selection instruction indicating that the reconnection is not to be performed.

4. The communication device according to claim 2, wherein
the radio wave for the reconnection is a radio wave indicating a DPP Reconfiguration Announcement.

5. The communication device according to claim 1, wherein
the reconnection unit transmits a radio wave indicating a DPP Reconfiguration Announcement and executes DPP Reconfiguration processing when the instruction receiving unit receives the selection instruction indicating that the reconnection is to be performed.

6. The communication device according to claim 5, wherein
when the connection is disconnected,
the reconnection unit transmits the radio wave indicating the DPP Reconfiguration Announcement to a terminal device, and
when the instruction receiving unit receives, from the terminal device, the selection instruction indicating that the reconnection is to be performed, the reconnection with the access point is performed by the DPP.

7. The communication device according to claim 1, wherein
the notification unit performs the notification when a predetermined time elapses after the connection with the access point connected by the DPP is disconnected.

8. The communication device according to claim 1, wherein
the notification unit performs notification, as at least part of the notification, of first information prompting selection of whether to perform the reconnection, and second information prompting selection of whether to provide notification of the first information at a next time or at subsequent times.

9. The communication device according to claim 1, wherein
the notification unit performs notification of information indicating that a standby state is in progress until the reconnection is established when the instruction receiving unit receives the selection instruction indicating that the reconnection is to be performed.

10. The communication device according to claim 1, wherein
the instruction receiving unit receives an interruption selection instruction for selecting whether to interrupt the reconnection during the reconnection by the reconnection unit, and
the reconnection unit interrupts the reconnection when the interruption selection instruction indicating interruption of the reconnection is received.

11. The communication device according to claim 1, wherein
the notification unit performs notification of information indicating a connection method that does not use the DPP when the instruction receiving unit receives the selection instruction indicating that the reconnection is not to be performed.

12. The communication device according to claim 1, wherein
the notification unit performs notification of information indicating that communication with the access point is not possible when the instruction receiving unit receives the selection instruction indicating that the reconnection is not to be performed.

13. A processing method performed by a communication device, comprising:
connecting to an access point by a Device Provisioning Protocol (DPP);
performing notification related to reconnection when a connection with the access point connected by the DPP is disconnected;
receiving a selection instruction for selecting whether to perform the reconnection; and
performing the reconnection with the access point by the DPP when performing the reconnection is selected.

14. A non-transitory computer-readable storage medium storing a program, the program causing a computer of a communication device to execute a process, the process comprising:
connecting to an access point by a Device Provisioning Protocol (DPP);
performing notification related to reconnection when a connection with the access point connected by the DPP is disconnected;
receiving a selection instruction for selecting whether to perform the reconnection; and
performing the reconnection with the access point by the DPP when performing the reconnection is selected.
